(19) United States
(12) Patent Application Publication
(10) Pub. No.: US 2017/0341274 A1
(43) Pub. Date: Nov. 30, 2017

(54) DEVICE AND METHOD FOR COATING A THREAD

(71) Applicants: COMPAGNIE GENERALE DES ETABLISSEMENTS MICHELIN, CLERMONT-FERRAND (FR); Michelin Recherche et Technique S.A., GRANGES-PACCOT (CH)

(72) Inventors: MARC SEBE, Clermont-Ferrand (FR); ANTONIO DELFINO, Clermont-Ferrand (FR); GABRIEL LIMAT, Clermont-Ferrand (FR)

(21) Appl. No.: 15/531,824

(22) PCT Filed: Dec. 14, 2015
(86) PCT No.: PCT/EP2015/079542

§ 371 Date: May 31, 2017

(30) Foreign Application Priority Data
Dec. 22, 2014 (FR) 1463088

(51) Int. Cl. B29B 15/12; B29C 70/52

(52) U.S. Cl. CPC B29B 15/122; B29C 70/523

(57) ABSTRACT

A device for coating a thread with a coating material includes a housing, a die body, and a supply line for the coating material. The housing includes a support and a cover mounted on the support, delimiting a chamber. The die body is installed in the chamber, between the support and the cover. The die body includes a lower part and an upper part, with a calibrated die channel being located between the lower and upper parts. Between the support and the cover are an inlet through passage and an outlet through passage. The inlet and outlet passages and the die channel are aligned, so that a thread is able to be passed longitudinally therethrough. The supply line for the coating material includes a lower outlet end located close to the thread, between the inlet or upstream through passage and the die channel.

The present invention relates to the field of the manufacture of filaments comprising a thread and a coating surrounding this thread.

It is known to incorporate filamentary reinforcing elements into the material constituting the tyres. In order to replace the filamentary reinforcing elements currently made of steel, filaments have been proposed that comprise a thread of glass fibres impregnated with a thermosetting resin, generally known by the abbreviation GFRP (glass-fibre reinforced plastic), surrounded by a layer of adhesive, in particular of resorcinol-formaldehyde latex, generally known by the abbreviation RFL, adhesive. A tyre incorporating non-metallic filaments is described in patent EP-A-1 167 089.

However, the manufacture of non-metallic filaments poses difficulties. Specifically, there is a difficulty linked to the fact that the GFRP thread has a smooth surface and is nonporous, so much so that it has no ability to absorb the layer of RFL adhesive. There is also a difficulty in obtaining a uniformity of the thickness of the layer of RFL adhesive, both circumferentially and in the length direction of the thread. There is also a difficulty linked to the polluting nature of the products used during the implementation thereof.

U.S. Pat. No. 3,231,414 describes a device for coating a thread with a coating material that comprises a platform on which the coating material is poured in order to form a mass of material and, on one side this platform, a plurality of dies. Threads to be coated pass through this mass of material and pass through the dies. Since the coating material uses the open air on the plate, it may undergo physical and chemical transformations that degrade the quality of the coating produced on the threads in the dies. The objective of the present invention is to meet the needs, in particular to provide solutions to the difficulties mentioned above.

According to one embodiment, a device for coating a thread with a coating material is proposed.

This coating device comprises a housing that comprises a support and a cover mounted on the support, delimiting a chamber, and a die body installed in said chamber, between the support and the cover; the support and the cover between them making an inlet through passage and an outlet through passage located on either side of said chamber, the die body comprising a lower part and an upper part that bear against one another, between them making a calibrated die channel, said inlet and outlet through passages and said calibrated die channel being aligned, so as to be able to be passed through longitudinally by the thread in the taut state; the die body delimiting a deposition space, located between the inlet through passage and the die channel and that can be passed through by the thread.

The coating device additionally comprises a coating product supply line, having a lower outlet end opening into said deposition space and located close to and above the thread.

Furthermore, the support has a lower outlet orifice from said chamber for discharging excess coating material originating from said deposition space and from said calibrated die channel.

The die body is held in said chamber, between the support and the cover, by interlocking of shapes.

The chamber has opposite adjustment sides between which the die body is engaged in an adjusted manner, a spring being installed between the die body and the cover to keep the die body bearing against at least one shoulder of the support.

The supply line may be attached to the upper part of the die and extends through a through passage of the cover.

The die body may comprise at least one transverse wall, the die channel comprising a calibrated die orifice made through this transverse wall.

Said transverse wall may be inclined relative to the direction of the thread.

The die body may comprise several spaced out transverse walls having a calibrated die orifice.

The die body may comprise containment walls located on either side of the supply line and having through-orifices passed through by the thread, these containment walls delimiting a deposition space that is open at the bottom.

A method for coating a thread with a coating material is also proposed.

This method comprises: making the thread, in a taut state, circulate longitudinally, from upstream to downstream through a deposition space then a calibrated longitudinal die channel of a die body installed in a chamber delimited by a housing; depositing coating material on the wire as it passes through said deposition space and calibrating the thickness of the coating of the thread as it passes through the calibrated die channel; and discharging the excess coating material originating from said deposition space and from said calibrated die channel.

The method may comprise: making the coated thread circulate through at least one oven.

The method may comprise: making the thread circulate through a first die body in order to coat the thread with a first layer of a first coating material, then through at least one oven, and, next, making the thread circulate through a second die body in order to coat the thread with a second layer of a second coating material, then through said oven.

The method may comprise: discharging the excess coating material to an intermediate tank, supplying the deposition space from this intermediate tank, supplying this intermediate tank from a storage tank.

A coating facility is also proposed, comprising at least one coating device and comprising at least one oven located downstream of this coating device.

Coating devices and a coating facility will now be described by way of nonlimiting examples, illustrated by the drawings in which:

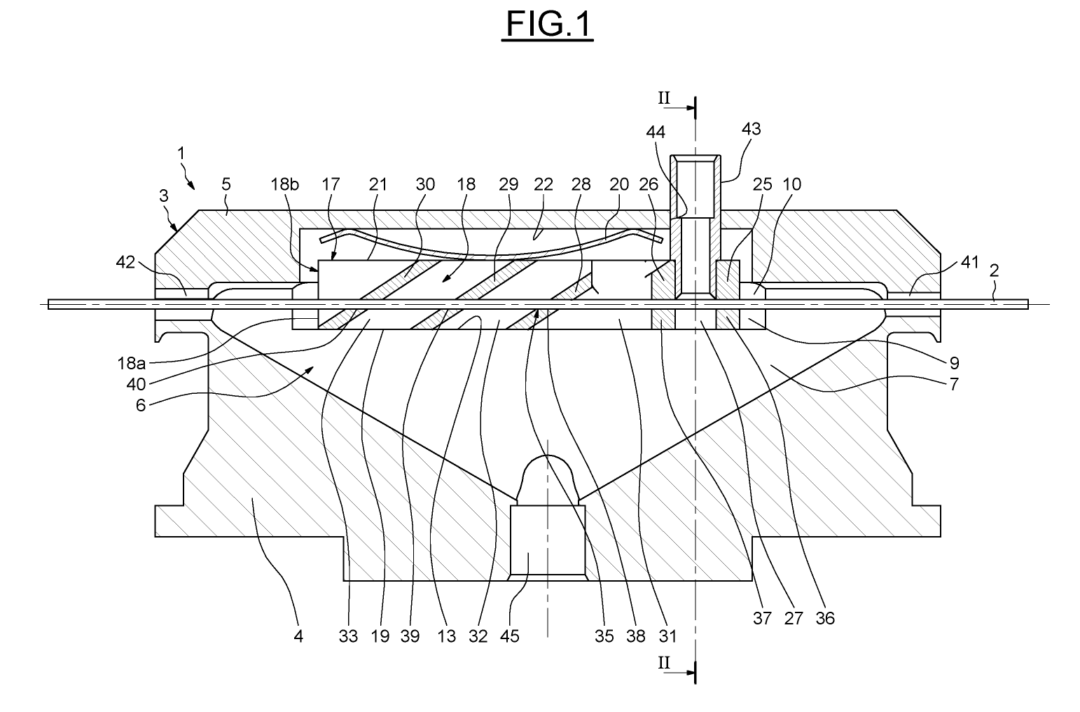

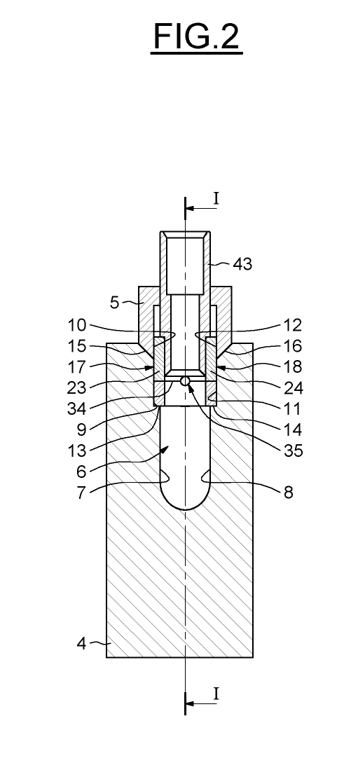

FIG. 1 represents a vertical longitudinal section of a coating device, along I-I from FIG. 2;

FIG. 2 represents a vertical transverse section of the coating device from FIG. 1, along II-II from this FIG. 1;

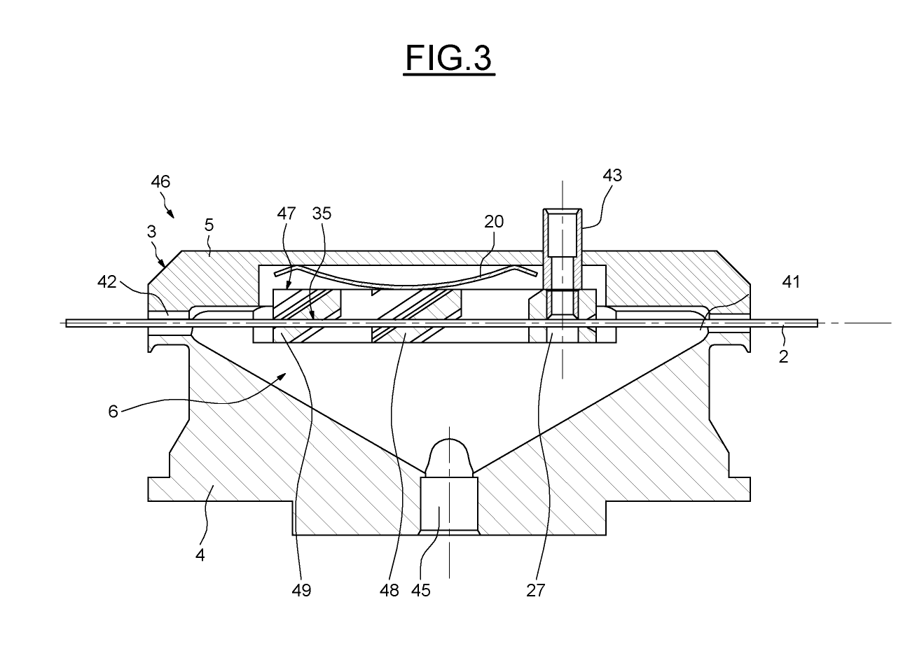

FIG. 3 represents a vertical longitudinal section of an embodiment variant of the coating device from FIG. 1;

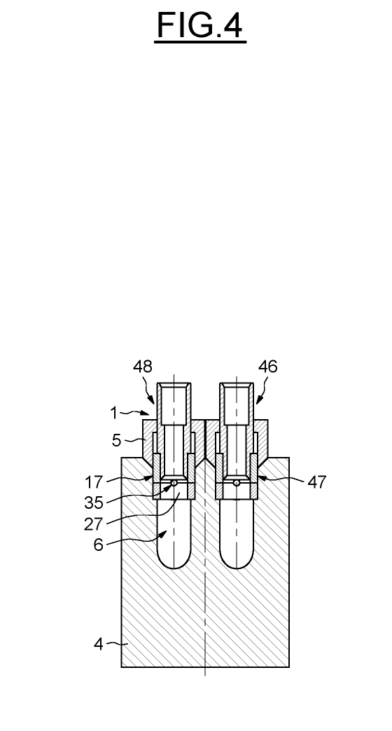

FIG. 4 represents a vertical transverse section of a coating assembly that includes two coating devices;

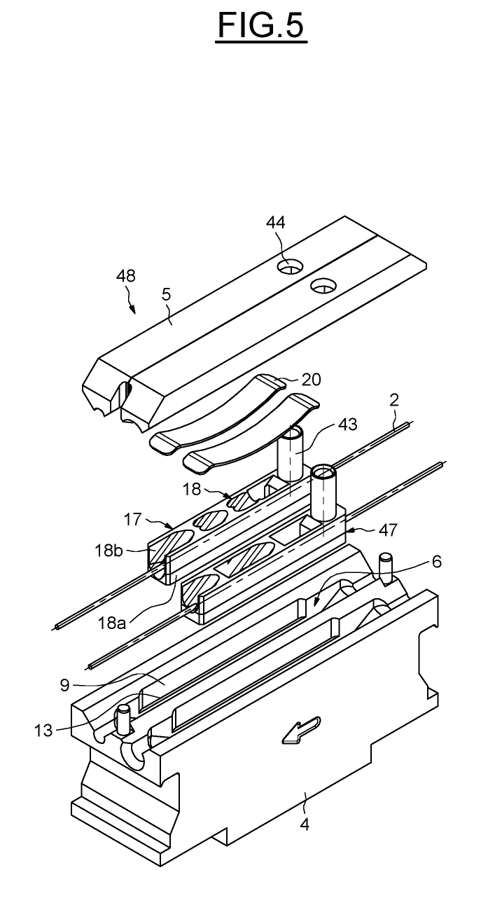

FIG. 5 represents an exploded perspective view of the coating assembly from FIG. 4; and

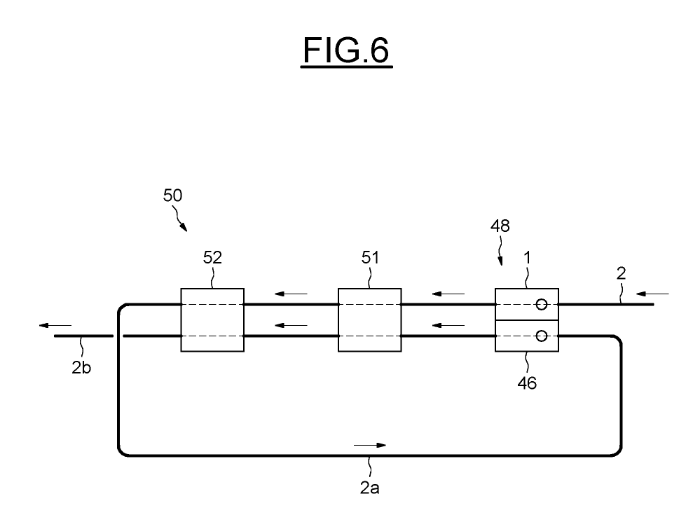

FIG. 6 schematically represents a coating facility that includes the above coating assembly.

As illustrated in FIGS. 1 and 2, a coating device 1 for coating a thread 2, comprises a housing 3 that comprises a lower support 4 and an upper cover 5 fastened in a removable and adjusted manner to the support 4. The support 4 and the cover 5 delimit a coating chamber 6 formed longitudinally and vertically, that comprises a large lower part made in the support 4 and a small upper part made in the cover 5.

The chamber 6 is delimited laterally by opposite longitudinal sides 7 and 8 formed in the support 4 and in the cover 5, in which opposite recesses are made, the backs of which form, on the one hand, longitudinal adjustment sides 9 and 10 made in the support 4 and in the cover 5, continuing one another vertically and, on the other hand, on the opposite side, longitudinal adjustment sides 11 and 12 made in the support 4 and in the cover 5, continuing one another vertically.

The longitudinal adjustment sides 9 and 11 of the support 4 meet the longitudinal sides 7 and 8 through upwardly oriented longitudinal bearing shoulders 13 and 14.

The cover 5 is adjusted on the support 4 by longitudinal mating surfaces 15 and 16 located on either side of the chamber 6 and forming a V that is open towards the top.

The cover 5 may be mounted on the support 4 by means of quick coupling means and the support 4 may be installed on a suitable table and attached thereto by quick coupling means, for example by toggle systems.

The coating device 1 comprises a die 17 which comprises a die body 18 that is in the form of an elongated parallelepiped, which is installed longitudinally within the chamber 6 and which extends across the chamber 6. The die body 18 is engaged in an adjusted manner between the adjustment sides 9 and 11 of the support 4 and between the adjustment sides 10 and 12 of the cover 5. The longitudinal edges of the lower face 19 of the die body 18 bear against the longitudinal bearing shoulders 13 and 14 of the support 4.

The die body 18 is kept bearing against the longitudinal bearing shoulders 13 and 14 by means of a blade-shaped spring 20 inserted between the upper face 21 of the die body 18 and the upper face 22 of the chamber 6 in the cover 5. To this purpose, a median portion of the spring 20 bears against the upper face 21 of the die body 18 and end portions of the spring 20 against the upper face 22 of the chamber 6.

Thus, the dye body 18 is held between the support 4 and the cover 5 by interlocking of shapes. Shapes other than those described above could be provided.

The die body 18 comprises two transversely spaced out longitudinal walls 23 and 24, in contact with the longitudinal adjustment sides 9, 10 and 11, 12.

At its so-called upstream end portion, the die body 18 comprises two transverse containment walls 25 and 26 that connect the two longitudinal walls 23 and 24, which are spaced out longitudinally and which between them delimit a deposition space 27 that is open at the bottom.

Between its upstream end portion and its so-called downstream end portion, the die body 18 additionally comprises three transverse walls 28, 29 and 30 which connect the two longitudinal walls 23 and 24 and which are spaced out longitudinally. The transverse walls 26, 28, 29 and 30 between them delimit spaces 31, 32 and 33 that are open from top to bottom. The walls 26, 28, 29 are inclined relative to the direction of the thread 2, from top to bottom and from upstream to downstream.

The die body 18 is divided into a lower part 18a and an upper part 18b bearing against one another through a mating surface 34 that extends longitudinally and transversely. For example, the lower part 18a is completely engaged in the support 4 and the upper part 18b is partially engaged in the support 4.

The lower and upper parts 18a and 18b of the die body 18 between them delimit a longitudinal die channel 35 that comprises calibrated circular die orifices 36, 37, 38, 39 and 40 respectively passing through the transverse walls 25, 26, 28, 29 and 30, half of these orifices being made in the lower part 18a and the other half being made in the upper part 18b.

The support 4 and the cover 5 between them delimit, upstream and at a distance from the upstream end of the die body 18, a circular inlet through passage 41 and, downstream and at a distance from the downstream end of the die body 18, a circular outlet through passage 42. Half of the through passages 41 and 42 are made in the support 4 and the other half are made in the cover 5.

The inlet and outlet through passages 41 and 42 and the calibrated die orifices 36, 37, 38, 39 and 40 forming the die channel 35 are aligned longitudinally so as to be able to be passed through longitudinally by the thread to be coated 2 in the taut state, the means for assembly of the cover 5 on the support 4 and of the die body 18 being suitable for ensuring this alignment in a precise manner. The inlet and outlet through passages 41 and 42 have much larger sections than the calibrated die orifices 36, 37, 38, 39 and 40, so as to allow the thread 2 to pass through freely.

The upper part 18b of the die body 18 is equipped with a supply line 43, the lower end of which is fastened in the upper part of the deposition space 27 so as to open above and close to the thread 2 that passes through this space. The line 43 passes through a passage 44 of the cover 5 so as to have an upper end located outside, to which a feed pipe for supplying a coating product may be connected.

The support 4 has, in its lower part, a lower outlet through orifice 45, at the bottom of the chamber 6 converging, in the support 4, towards this outlet orifice 45.

The coating device 1 that has just been described may be used and may operate in the following manner.

The thread to be coated 2 travels longitudinally from upstream to downstream. The inlet and outlet passages 41 and 42 have significantly larger sections than the section of the thread 2 so as to allow the thread to pass through freely.

The coating product, generally in the paste state, is brought by the supply line 43 to the deposition space 27 and flows downwards. The thread 2 passes through, in this deposition space 27, the coating product and carries it with it. Owing to the fact that the thread 2 passes successively through the orifice 37 of the wall 26 and the calibrated die orifices 38, 39 and 40 of the walls 28, 29 and 30, the remaining thickness of the coating product around the thread 2, after the latter has left the dye 17, is calibrated.

In the chamber 6, the excess coating product brought into the deposition space 27 flows downwards by gravity and the excess coating product is scraped off by the upstream faces of the walls 38, 39 and 40 around the thread 2 and flows downwards by gravity, from the intermediate spaces 37, 38 and 39, in order to be discharged to the outside through the lower outlet orifice 45 of the chamber 6.

The coating device 1 is particularly easy to dismantle. It is sufficient to dismantle the cover 5, to remove the spring 20, to extract the upper part 18a of the die 17, optionally to move the thread 2 aside if it is still present and to extract the lower part 18b of the die 17. This being done, the cleaning thereof can easily be carried out.

Reassembly can be carried out in the reverse manner. Advantageously, the thread 2 may be installed as described above after installing the lower part 18a of the die body 18 in the support 4 and before installing the upper part 18b of the die body 18, the spring 20 and the cover 5.

In addition, the coating product remains contained inside the chamber 6, so that it is not exposed to light and to possible external pollution and does not produce external pollutants.

As illustrated in FIG. 3, a coating device 46 differs from the coating device 1 only by the fact that it is equipped with a die 47 which replaces the die 17 and which comprises, as an embodiment variant, a die body that comprises only two transverse walls 48 and 49, having calibrated die orifices, instead of the three walls 28, 29 and 30. According to another embodiment variant, provision may be made for a single transverse wall or more than three transverse walls having calibrated die orifices.

As illustrated in FIGS. 4 and 5, a coating assembly 48 comprises, as an embodiment variant, the coating device 1 and the coating device 46, which are formed independently but have a common support 4. In this coating assembly 48, the coating devices 1 and 46 are positioned parallel, one next to the other, and with the same layout, their upstream parts and their downstream parts respectively being adjacent.

By referring to FIG. 6, a coating facility 50 and its method of operation will now be described, which are more specifically intended for coating a GFRP thread (glass fibres impregnated with a thermosetting resin) with firstly an intermediate layer of epoxy adhesive, then a layer of RFL (resorcinol-formaldehyde latex) adhesive.

The coating facility 50 comprises the coating assembly 48, a first hot-air drying oven 51, for example at a temperature of around 100°, and a second hot-air curing oven 52, for example at a temperature of around 230°, which are for example positioned on a virtually rectilinear production line.

The thread 2 follows the following path, the facility 50 comprising means, not represented, for making it circulate and keeping it taut.

The thread 2, arriving upstream, passes from upstream to downstream through the coating device 1 in which it is coated with a layer of epoxy adhesive that supplies the latter.

Then, the coated thread 2 passes through the first oven 51 in which the water contained in the epoxy adhesive is expelled.

Then, the coated thread 2 passes through the second oven 52 in which the epoxy adhesive is cured. A first filament 2a is obtained.

Next, this filament 2a is diverted, owing to means not represented, in order to arrive upstream of the coating device 46.

Then, the filament 2a passes from upstream to downstream through the coating device 46 in which it is coated with a layer of RFL adhesive, on top of the cured epoxy adhesive layer.

Then, the coated filament 2a again passes through the first oven 51 in which the water contained in the RFL adhesive is expelled.

Then, the coated filament 2a again passes through the second oven 52 in which the RFL adhesive is cured.

Finally, the thread 2 coated with a cured epoxy adhesive layer then a cured RFL adhesive layer forms a final filament 2b that may be discharged.

Since the coating products such as the epoxy adhesive and the RFL adhesive are sensitive, it may be desirable for the products discharged from the chambers 6 through the lower outlet orifices 45 of the coating devices 1 and 46 to be sent to small-volume intermediate recirculation tanks, from which the coating products are sent back to the feed lines 43 of the coating devices 1 and 46. These intermediate tanks may be supplied from storage tanks, depending on the amounts consumed in the coating devices 1 and 46.

Owing to the easy dismantling and reassembly of the elements forming the coating devices 1 and 46, as described above, the latter may be cleaned frequently in order to ensure the regularity and the uniformity of the coatings to be produced, without it being necessary to cut the thread 2 since it is sufficient to move it aside.

The present invention is not limited to the examples described above. Many embodiment variants are possible without departing from the scope of the invention.

1-13: (canceled)

14: A device for coating a thread with a coating material, the device comprising:
a housing that includes a support and a cover mounted on the support, delimiting a chamber;
a die body installed in the chamber, between the support and the cover,
wherein between the support and the cover are an inlet through passage and an outlet through passage,
wherein the chamber is located between the inlet through passage and the outlet through passage,
wherein the die body includes a lower part and an upper part that bear against one another, with a calibrated die channel being located between the lower part and the upper part,
wherein the inlet through passage, the outlet through passage, and the die channel are aligned so that a thread in a taut state is able to be passed longitudinally therethrough, and
wherein the die body delimits a deposition space located between the inlet through passage and the die channel, the deposition space being able to be passed through by the thread; and
a supply line for supplying coating material, the supply line including a lower outlet end that opens into the deposition space, and the supply line being located close to and above the thread,
wherein the support includes a lower outlet orifice from the chamber for discharging excess coating material from the deposition space and from the die channel.

15: The device according to claim 14, wherein the die body is installed in the chamber between the support and the cover by an interlocking of shapes.

16: The device according to claim 14, wherein
the chamber includes opposite adjustment sides between which the die body is engaged in an adjustable manner, and
a spring is being installed between the die body and the cover to cause the die body to bear against a shoulder of the support.

17: The device according to claim 14, wherein the supply line is attached to the upper part of the die body and extends through a through-passage of the cover.

18: The device according to claim 14, wherein
the die body includes a transverse wall, and
the die channel includes a calibrated die orifice that extends through the transverse wall.

19: The device according to claim 18, wherein the transverse wall is inclined relative to a direction of the thread.

20: The device according to claim 18, wherein the die body includes a plurality of transverse walls spaced apart from each other, with each of the transverse walls including a calibrated die orifice.

21: The device according to claim 14, wherein
the die body includes containment walls located on opposite sides of the supply line,
the containment walls have through-orifices for enabling the thread to pass therethrough, and
the containment walls delimit the deposition space, with a bottom portion of the deposition space being open.

22: A method for coating a thread with a coating material, the method comprising:
longitudinally circulating a thread, in a taut state, from upstream to downstream through a deposition space and then a calibrated longitudinal die channel of a die body installed in a chamber delimited by a housing;
depositing coating material on the thread as the thread passes through the deposition space to form a coated thread, and calibrating a thickness of a coating of the coated thread as the coated thread passes through the die channel; and
discharging excess coating material from the deposition space and from the die channel.

23: The method according to claim 22, further comprising circulating the coated thread through at least one oven.

24: The method according to claim 22, further comprising:
circulating the thread through a first die body in order to coat the thread with a first layer of a first coating material, and then circulating the thread through at least one oven; and
circulating the thread, which has been coated with the first coating material, through a second die body in order to coat the thread with a second layer of a second coating material, and then circulating the thread through the at least one oven.

25: The method according to claim 22, further comprising discharging the excess coating material to an intermediate tank, supplying the deposition space from the intermediate tank, supplying the intermediate tank from a storage tank.

26: A coating facility comprising:
at least one coating device for coating a thread with a coating material; and
at least one oven located downstream of the at least one coating device, wherein each coating device includes:
a housing that includes a support and a cover mounted on the support, delimiting a chamber,
a die body installed in the chamber, between the support and the cover,
wherein between the support and the cover are an inlet through passage and an outlet through passage,
wherein the chamber is located between the inlet through passage and the outlet through passage,
wherein the die body includes a lower part and an upper part that bear against one another, with a calibrated die channel being located between the lower part and the upper part,
wherein the inlet through passage, the outlet through passage, and the die channel are aligned so that a thread in a taut state is able to be passed longitudinally therethrough, and
wherein the die body delimits a deposition space located between the inlet through passage and the die channel, the deposition space being able to be passed through by the thread, and
a supply line for supplying coating material, the supply line including a lower outlet end that opens into the deposition space, and the supply line being located close to and above the thread,
wherein the support includes a lower outlet orifice from the chamber for discharging excess coating material from the deposition space and from the die channel.
